(19) United States
(12) Patent Application Publication
(10) Pub. No.: US 2024/0010485 A1
(43) Pub. Date: Jan. 11, 2024

(54) Cleaning device for beverage dispenser nozzle

(71) Applicant: Quality Mark, Inc., Shafer, MN (US)

(72) Inventors: Jeffrey McCollum, Minneapolis, MN (US); Mark Ebbenga, Shafer, MN (US)

(21) Appl. No.: 18/220,433

(22) Filed: Jul. 11, 2023

Related U.S. Application Data
(60) Provisional application No. 63/388,121, filed on Jul. 11, 2022.

(51) Int. Cl. B67D 1/07

(52) U.S. Cl. CPC B67D 1/07

(57) ABSTRACT

A method and device for cleaning a beverage dispenser diffuser. The device is removably coupled to the beverage dispenser and creates a vortex in within the device when fluid is dispensed from the diffuser to clean the inside of the diffuser. The cap has a main body with a base portion having an open end for receipt of the diffuser, a cleaning chamber, and a vortex creator configured to create a vortex within the beverage dispensing diffuser from fluid dispensed from the diffuser.

### CROSS-REFERENCE TO RELATED APPLICATION

The present application claims priority to and the benefit of U.S. provisional application Ser. No. 63/388,121, filed on Jul. 11, 2022, the contents of which are hereby incorporated in their entirety.

### BACKGROUND

The present invention relates to a quick-install cleaning nozzle or cap for cleaning a diffuser of a manual beverage dispenser such as a beverage gun. More specifically, the present invention relates to a cleaning nozzle or cap for creating a high pressure fluid flow in a chamber around the diffuser or dispensing port of the manual beverage dispenser to clean the beverage dispenser easily.

Various beverage dispensers such as those found in restaurants, bars and other entertainment venues and/or food service establishments typically have a manual beverage dispenser. The dispenser may be hand-held dispenser sometimes referred to as a “soda gun.” In conventional dispensing systems with a dispensing gun, the dispensing gun is connected to a number of beverage concentrate supply sources via lines designed to deliver a specific beverage concentrate to the dispensing gun. The lines also deliver a charged water or carbonated water flow to the dispenser.

These manual beverage dispensers typically are used to dispense various liquids including those drinks having a sugar content. The manual beverage dispensers have a dispensing nozzle that covers an outlet for the liquid flow, usually through a diffuser that accumulates bacteria quickly. It is time consuming and undesirable for workers to manually clean the beverage dispenser nozzle nightly or even weekly. Cleaning generally requires disassembly of the gun to fully remove bacterial buildup or even mold that grows in the dispensing nozzle and on the diffuser. Cleaning these devices is imperative for overall sanitization and cleanliness, but also to preserve the original taste of the beverages dispensed.

### SUMMARY

An aspect of the present disclosure relates to a device for removably coupling to a beverage dispenser to clean the beverage dispensing diffuser. The device includes a main body having a base portion having an open end therein for coupling to the beverage dispenser, a cleaning chamber, and a cleaning flow creator configured to create a pressurized fluid flow around and/or within the cleaning nozzle and which cleans the beverage dispenser including the diffuser that is received within the base portion, the flow generated from fluid dispensed from the beverage dispensing nozzle is sufficient to physically clean the dispenser including the diffuser.

The cleaning flow creator comprises a truncated conical surface positioned at least partially within an interior of the cleaning chamber.

The cleaning flow creator is a truncated conical surface wherein a base of the truncated conical surface is positioned within the cleaning chamber and at a distal end of the cleaning chamber and extends towards a proximal end of the cleaning chamber wherein the proximal end of the cleaning chamber terminates in connection with the base portion.

An inner surface of the base portion comprises a coupling mechanism for removably coupling the device to the beverage dispenser. The nozzle coupling mechanism comprises a screw top, a plurality of spaced apart tabs such that the nozzle coupling mechanism frictionally engages with an exterior surface of the beverage dispenser, or other snap on means for securing the cleaning nozzle to the beverage dispenser.

The cleaning chamber is a truncated cone having a drain port in a top surface and wherein a bottom of the cleaning chamber is open and configured to receive a tip of the beverage dispenser passing through the base portion into the cleaning chamber.

In one or more embodiments the device further comprises an open space between an outer surface of the cleaning flow creator and an inner surface of the cleaning chamber.

In one or more embodiments, the cleaning nozzle is a cap that is removable and reusable.

Another aspect of the present disclosure relates to a device for cleaning a handheld beverage dispenser, the device comprises a cleaning nozzle cap comprising a cleaning chamber, a cleaning flow creator and a drain port and wherein the cleaning nozzle cap is removably connectable to the beverage dispenser and configured to clean the diffuser and/or outlet port of the beverage dispenser.

The cleaning nozzle may be used with or without removing the dispensing nozzle from the beverage dispensing system with dispensing of charged or carbonated water from the nozzle.

The device is configured to receive a liquid such as charged water or carbonated water with or without a solid sanitizing component therein for mixing or dissolving in the liquid dispensed from the beverage dispenser such that the cleaning flow cleans and sanitizes the nozzle and is sufficient to do so without sanitizing chemicals.

In one or more embodiments, the beverage dispensing system is a manual beverage dispensing system comprising a handheld controller supporting the nozzle.

In one or more embodiments, the cleaning nozzle cap also includes further comprising an external surface tab having an aperture therein.

Yet another aspect of the present disclosure relates to a method of cleaning a beverage dispensing system. The method includes coupling a cleaning nozzle cap having an interior cavity with one or more conical surfaces therein to the beverage dispensing system, dispensing a fluid from the beverage dispensing system for a selected duration of time, generating a cleaning flow with the fluid within the nozzle to physically clean interior surfaces of the beverage dispensing system, and after cleaning, removing the cleaning nozzle cap from the beverage dispensing system.

The fluid is a charged water or carbonated water flow and wherein the fluid is dispensed without increasing the water pressure or flow rate above those used to dispense liquid from the beverage dispensing system under standard beverage dispensing conditions. The pressure generated within the cleaning nozzle is sufficient to clean a diffuser or liquid outlet of the beverage dispensing system.

The nozzle may be further sanitized, where sanitizing the nozzle is carried out by adding a sanitizing chemical to the cap to mix with the fluid in the vortex.

The selected duration of time for cleaning is in the range of 5 seconds to 5 minutes.

The selected duration of time for cleaning is less than 5 seconds.

### BRIEF DESCRIPTION OF THE DRAWINGS

FIG. 1 is a front perspective view of the cleaning chamber.

FIG. 2 is a bottom perspective view of the cleaning chamber.

FIG. 3 is a side view of the cleaning chamber in use with a manual beverage dispenser.

FIG. 4 is an exploded view of a cleaning chamber according to one or more of the embodiments described herein.

FIG. 5 is a bottom view of the cleaning chamber.

FIG. 6 is a front perspective view of another embodiment of the cleaning chamber.

### DETAILED DESCRIPTION

A nozzle cap for cleaning and optionally sanitizing a diffuser of a beverage dispenser is described herein. The nozzle cap is a removable and reusable assembly configured to couple to the diffuser or outlet end of the beverage dispenser for cleaning and/or sanitizing. Most beverage dispensers are connected to a water line where the water line may be charged water and/or carbonated water. By dispensing a liquid, such as charged or carbonated water, with the beverage dispenser, the nozzle cap coupled to the beverage dispenser produces a cleaning flow which can safely and effectively flush clean the diffuser and the surface area behind and/or around the diffuser which directs fluid flow from the outlet for beverage delivery from the system.

The cleaning flow is an actual change to the fluid flow dynamics of the fluid leaving the beverage dispenser, generally through the diffuser or similar flow control element. That is, the cleaning flow physically removes built up debris on surfaces of the beverage dispenser diffuser and when a sanitizing component is provided therewith, also sanitize the surfaces. The flow from the beverage dispenser is a generally laminar flow through a diffuser mechanism, wherein the cleaning flow generated by the nozzle cap described herein may be a non-laminar flow, a flow with eddies, swirls, or currents normal to the flow itself, a turbulent flow, or in some embodiments a vortex. The flow is sufficiently pressurized and/or turbulent within the cleaning nozzle and as directed by the cleaning nozzle surfaces to clean the diffuser of the beverage dispenser.

In one or more embodiments, the nozzle cap is also configured to support a supply of sanitizer therein such that the cleaning chamber can be provided with a sanitizing material for coupling to the beverage dispenser. The sanitizing material is then used with the liquid cleaning flow to clean and sanitize the beverage dispenser, diffuser, and its surface areas where bacteria, mold and other organic material may accumulate. The sanitizing material may be a tablet or solid material that dissolves in water to sanitize surfaces by wiping or soaking the surface with the sanitizing solution formed.

The nozzle cap has one or more internal surfaces that produce the cleaning flow when liquid is dispensed from the beverage dispenser. The liquid flow from the beverage dispenser through its outlet and/or diffuser is not adjusted, but rather exits the beverage dispenser and is directed into and against one or more internal surfaces of the nozzle cap, which change the fluid flow from the beverage dispensing diffuser into a non-laminar, turbulent fluid flow or other physical cleaning flow. The cleaning flow is formed inside the cleaning nozzle coupled to the beverage dispenser and the fluid thus surrounds and contacts the diffuser surfaces at one or more angles, including at least the inner surfaces of the diffuser where bacteria and mold may accumulate. The cleaning flow thus physically removes built up material on these beverage dispensing and/or diffuser surfaces. In embodiments where a sanitizing material is provided to the nozzle cap, the cleaning flow is also a sanitizing cleaning flow which further cleans and sanitizes the inner surfaces of the beverage dispenser including the diffuser.

The nozzle cap is a cleaning and sanitizing device that is removable and reusable. The nozzle cap cleans a preexisting beverage dispensing diffuser, without removal of the diffuser from the beverage dispensing system and without requiring modification to the normal operation of the beverage dispensing system. The diffuser may be provided with a dispensing nozzle over the diffuser, which may or may not be removed when the cleaning nozzle cap is coupled to the beverage dispenser. The nozzle cap is removably coupled to the dispensing end and/or around the diffuser end of the beverage dispenser and charged or carbonated water is dispensed from the dispenser and into the cleaning nozzle cap. The nozzle cap uses the beverage dispensing systems own water flow rate and water pressure in combination with the internal structure and surfaces of the nozzle cap to create a change in the fluid flow into the cleaning flow within the cleaning nozzle to remove bacteria, mold, and other grime or buildup inside and around the diffuser and to flush the dispenser diffuser and surfaces therearound clean. Optionally, detergents or other sanitizing products can be provided to the nozzle cap for sanitizing the diffuser connected thereto. The nozzle cap can be coupled to the beverage dispenser and removed from the dispenser manually and without the use of additional tools or hardware. The cleaning nozzle cap is secured to the beverage dispenser by a mechanism capable of withstanding the pressure generated from the fluid flow from the beverage dispenser without popping off the beverage dispenser.

The cleaning nozzle cap described herein effectively throttles the fluid flow from the beverage dispenser and directs at least some of the fluid flow direction back towards the diffuser for cleaning. The fluid is drained from the outlet end of the cleaning nozzle cap during cleaning but the flow through the nozzle cap is distinct from the flow generally ejected from the beverage dispenser without the cleaning nozzle cap coupled thereto.

In one or more embodiments illustrated herein the beverage dispenser is a manual beverage dispenser and more specifically is a hand-held beverage dispenser. The nozzle cap described in one or more embodiments herein may be used with any such beverage dispenser having a fluid dispensing outlet, which includes a diffuser or like element for fluid flow control, including hand-held beverage dispensing “guns.”

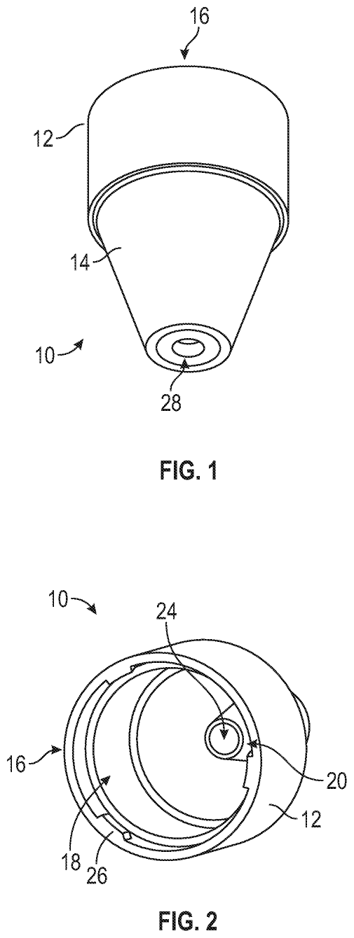

In one or more embodiments and referring to FIGS. 1-3, the nozzle cap 10 is a housing 12 having a base end 14 with opening or inlet 16 configured for receiving a diffuser 30 of a beverage dispenser therein. An interior surface of the base end 14 may comprise one or more surface elements or mechanisms 26 for securing the nozzle cap 10 to the diffuser 30 inserted therein.

A tip end 18 of the housing 12 may be conical in shape along its length and truncated at a terminal end thereon. The tip end 18 supports one or more internal surfaces 20 which generate or form a turbulent fluid flow in the liquid ejected from the diffuser 30 inserted into the nozzle cap 10.

The tip end 18 may have an opening or a drain port 28 in the terminal end. The tip end 18 may also have one or more spaces configured for receiving and/or supporting the addition of a sanitizing material such as a powder, tablet, or fluid within the nozzle cap 10. The nozzle cap 10 may support the addition of sanitizing material within the cap 10 such that the fluid flow from the diffuser 30 contacts, dissolves and/or carries the sanitizer in the fluid and in the non-laminar and/or turbulent flow to sanitize and clean interior surfaces of the diffuser 30. Sanitizer may be provided at or near the drain port 28 or held by the one or more internal surfaces 20 which generate or form the turbulent fluid flow in the liquid.

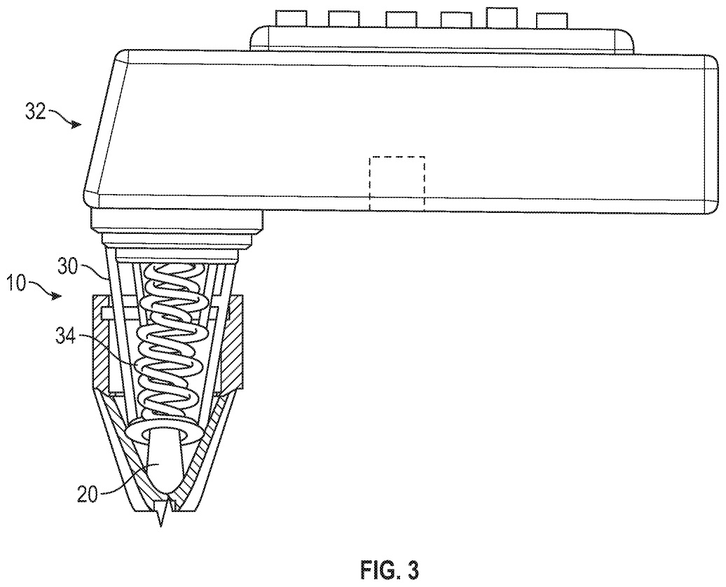

In the embodiment illustrated in FIGS. 1-3, the one or more internal surfaces 20 comprise a conical surface 21 having a length that extends from the tip end 18 of the nozzle cap 10 towards the base end 12 and wherein this conical surface 21 has dimensions such that the conical surface 21 is positioned within the interior of the tip end 18 and an outlet end 24 of the conical surface 21 is positioned at, near or partially extending into an outlet of the diffuser 30 to direct the fluid ejected therefrom into the turbulent flow. The conical surface may have an interior and exterior surface configuration such that the turbulent flow generated is a cleaning flow 34 within the interior of the diffuser 30 as shown in FIG. 3.

The surface elements or mechanisms 26 for securing the nozzle cap 10 to the diffuser 30 inserted therein may comprise spaced apart tabs or protrusions from the interior surface of the base end 12 such that these spaced apart tabs 26 couple to the external surface geometry of the diffuser 30 to securely but removably couple the nozzle cap 10 to the beverage dispenser 32. The mechanism for coupling the nozzle cap 10 to the beverage dispenser 32 may also include threaded fastening means or other means sufficient to retain a sealed connection between the nozzle cap 10 and the beverage dispenser 32 while high pressure flow is generated during cleaning. Fluid is generally ejected from the diffuser 30 of a beverage dispenser 32 at a flow rate in the range of 1.25-3.8 oz/second and the pressure on the fluid line in manual beverage dispensing systems can operationally be in the range of 130-150 PSI. Using charged water or carbonated water as the fluid dispensed from the diffuser 30, the otherwise laminar water flow from diffuser 30 is directed into a cleaning flow 34 by the coupling of the nozzle cap 10 to the beverage dispenser 32 during fluid dispensing. The charged or carbonated water is dispensed for a selected amount of time and the cleaning flow 34 generated within the diffuser 30 for cleaning and optionally sanitizing as well.

The nozzle cap 10 according to one or more embodiments can be coupled to the beverage dispenser 32 to clean the diffuser and adjacent surfaces without significantly adjusting the fluid flow of the fluid dispensed through the diffuser. That is, the cleaning flow is generated by the cleaning nozzle cap under normal or standard beverage dispensing settings. No additional equipment or pumps are needed to increase the pressure or flow rate of the dispensed fluid for cleaning. The nozzle cap 10 cleans the dispenser 30 by way of dispensing the fluid, generally water, from the nozzle with the cap 10 thereon for a selected duration of time that may be adjusted based on the extent of buildup on the nozzle surfaces for example. The cap 10 may be coupled to the nozzle and fluid dispensed from the beverage dispenser through the nozzle for a time in the range of about 2 seconds to 5 minutes or more, and optionally in the range of about 3 to 5 seconds. In one or more embodiments, cleaning of the nozzle is completed with a fluid dispensing time of under about 5 minutes, under about 2 minutes, under about 30 seconds or under about 5 seconds with the cap 10 coupled to the beverage dispenser 32.

A sanitizing material, for example, a tablet can be inserted into the cap 10 and dissolved by the water flow though the cap 10 and into the diffuser 30. The duration of the cleaning may then be dependent on the contact time or “soaking time” required by the specific sanitizing chemical to effectuate sanitizing of the surfaces of the nozzle.

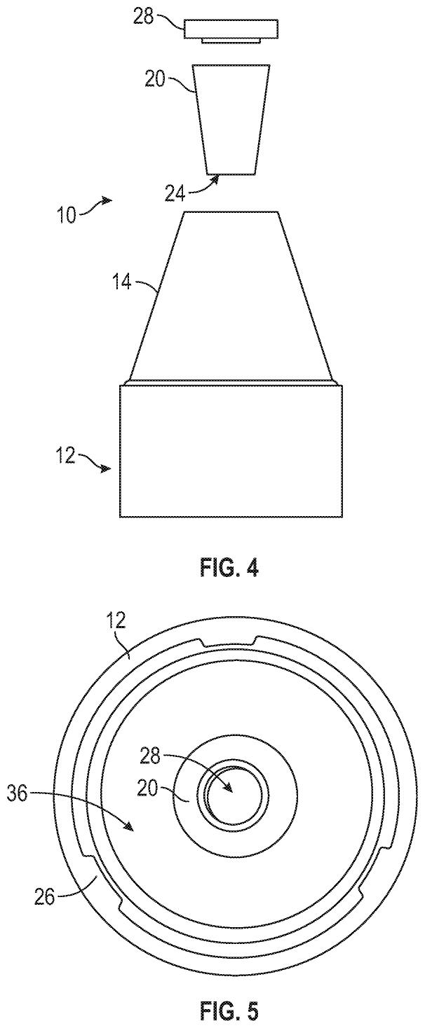

In one embodiment as illustrated in FIGS. 4-5, the nozzle cap 10 is cylindrical along the base 12 with an open interior and the tip end 18 is a truncated cone with an interior surface 36 that may also be sloped along the length of the tip end 18 towards the drain port 28. The cleaning flow creator 20 is also a truncated cone wherein the opening 24 extends near the base end 12 of the nozzle cap 10. The conical surface 21 may have a sloped length that extends from the terminal end or drain port 28 of the nozzle cap 10 inwardly towards the base end 12 of the nozzle cap wherein the length of the conical surface is in the range of about ½ to about ⅓ the overall length of the nozzle cap 10.

The tip end 18 has an interior surface 36 that may be sloped in a manner that corresponds to the exterior surface dimensions of the tip end 18. The interior surface 36 may further have a curvature. The direction of the slope of the conical surface 21 may be opposite to the direction of the slope of the exterior surface of the tip end 18 and may further be opposite the direction of the slope of the interior surface 36 of the tip end 18. There remains an open interior cavity or space 38 between the interior surface 36 and the vortex creator 20 within the tip end 18.

In one or more embodiments, the nozzle cap 10 is a unitary and monolithic housing formed by injection molding with a hard plastic material. In one or more embodiments the nozzle cap 10 is generally a housing 12 having a first end with an opening 16 for connecting or coupling to the diffuser 30 of a beverage dispenser 32 and comprising a cleaning chamber 18 and a cleaning flow creator 20 with a drain port 28 in a second end of the housing 12. The nozzle cap 10 has a mechanism 26 to securely and removably couple the nozzle cap 10 the diffuser 30. The mechanism 26 may comprise one or more tabs or openings in the surface that frictionally engage with the exterior surface of the diffuser 30.

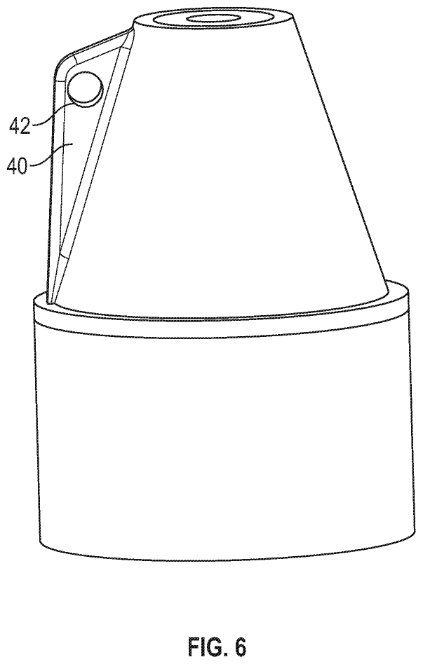

In the embodiment illustrated in FIG. 6, the nozzle cap 10 may comprise a tab 40 or other surface extending from an exterior surface of the cap 10 and having an aperture 42 therein which allows for connection of a lanyard or other mechanism or accessory, and/or allows the cap 10 to by hung on a hook or the like for drying or storage via connection with the aperture 10.

The nozzle cap according to one or more embodiments herein allows for a quick cleaning of the diffuser and/or adjacent surfaces of the beverage dispenser and thus eliminates an environment that attracts fruit flies, which can be especially prominent in warmer climates. Use of the nozzle cap also eliminates the need for overnight or long soaking of hand-held beverage dispensers. For example, one practice used may be to soak the hand-held beverage dispenser or “bar gun” in a pitcher of water with cleaning agent overnight. This practice can result in damage to the beverage gun and nozzle including pitted stem controls and/or cause leaks. This practices further fails to remove built up materials. Use of the cleaning nozzle as described here eliminates the need for such a practice and can extend the useful life of the beverage dispenser.

Although the present disclosure has been described with reference to preferred embodiments, workers skilled in the art will recognize that changes may be made in form and detail without departing from the spirit and scope of the disclosure.

1. A device for removably coupling to a beverage dispenser, the device comprising:
a main body comprising:
a base portion having an open end therein for receiving a diffuser end of the beverage dispenser therein;
a cleaning chamber; and
a cleaning flow creator configured to create a cleaning flow for one or more surfaces of the beverage dispensing diffuser received within the base portion from fluid dispensed from the beverage dispensing diffuser, wherein the cleaning flow is sufficient to physically clean surfaces of the beverage dispensing diffuser.

2. The device of claim 1, wherein the cleaning flow creator comprises a truncated conical surface positioned at least partially within an interior of the cleaning chamber.

3. The device of claim 2, wherein the cleaning flow creator is a truncated conical surface wherein a base of the truncated conical surface is positioned within the cleaning chamber and at a distal end of the cleaning chamber and extends towards a proximal end of the cleaning chamber wherein the proximal end of the cleaning chamber terminates in connection with the base portion.

4. The device of claim 1, wherein an inner surface of the base portion comprises a coupling mechanism for removably coupling the device to the beverage dispenser.

5. The device of claim 4, wherein the coupling mechanism comprises a threaded end or plurality of spaced apart tabs such that the nozzle coupling mechanism frictionally engaged with an exterior surface of the beverage dispenser.

6. The device of claim 1, wherein the cleaning chamber is a truncated cone having a drain port in a top surface and wherein a bottom of the cleaning chamber is open and configured to receive a tip of the beverage dispenser including the diffuser passing through the base portion into the cleaning chamber.

7. The device of claim 2, and further comprising an open space between an outer surface of the cleaning flow creator and an inner surface of the cleaning chamber.

8. The device of claim 1, wherein the cap is removable and reusable.

9. The device of claim 1, wherein the cleaning flow cleans one or more surfaces within the beverage dispensing nozzle and wherein the fluid dispensed from the beverage dispensing nozzle is transformed into the cleaning flow without altering a flow rate or PSI of the fluid flow.

10. The device of claim 1, and further comprising an external surface tab having an aperture therein.

11. A device for cleaning a nozzle of a beverage dispensing system, the device comprising a nozzle cap comprising a cleaning chamber, a cleaning flow creator and a drain port and wherein the nozzle cap is removably connectable to the beverage dispensing system and configured to clean the diffuser of the beverage dispensing system without removing the diffuser from the beverage dispensing system and while dispensing charged or carbonated water from the beverage dispenser.

12. The device of claim 11, and further configured to receive a liquid or a solid sanitizing component therein for mixing or dissolving in the water dispensed from the diffuser such that the vortex cleans and sanitizes the diffuser.

13. The device of claim 11 wherein the beverage dispensing system is a manual beverage dispensing system comprising a handheld controller supporting the diffuser.

14. A method of cleaning a nozzle of a beverage dispensing system comprising:
coupling a cap having an interior cavity with one or more conical surfaces therein to a dispensing end of the beverage dispensing system;
dispensing a fluid from the beverage dispensing system for a selected duration of time;
generating a non-laminar flow with the fluid within the nozzle to clean interior surfaces of the beverage dispensing end of the beverage dispenser; and
removing the cap from the beverage dispenser.

15. The method of claim 14 wherein the fluid comprises charged water or carbonated water and wherein the fluid is dispensed without increasing the water pressure or flow rate above those used to dispense water under standard beverage dispensing conditions.

16. The method of claim 14 and further comprising sanitizing the dispensing end of the beverage dispenser by adding a sanitizing chemical to the cap to mix with the fluid in the vortex.

17. The method of claim 14 wherein the selected duration of time for cleaning is in the range of 2 seconds to 5 minutes.

18. The method of claim 14 and further comprising hanging the cap from a hook or lanyard by connecting the same to an aperture in a tab extending from an exterior surface of the cap.

19. The method of claim 14 wherein the dispensing end of the beverage dispenser comprises a diffuser and the fluid flow generated in the cap is sufficient to clean the diffuser.
